(19) United States
(12) Patent Application Publication
(10) Pub. No.: US 2009/0169089 A1
(43) Pub. Date: Jul. 2, 2009

(54) Cell Analysis

(75) Inventors: Simon Hunt, Oxford (GB); Steve Young, Oxford (GB); Oleg Salata, Oxford (GB); Stephen Payne, Oxford (GB)

Correspondence Address: NIXON & VANDERHYE, PC, 901 NORTH GLEBE ROAD, 11TH FLOOR, ARLINGTON, VA, 22203, US

(73) Assignee: ISIS INNOVATION LIMITED, Summertown (GB)

(21) Appl. No.: 11/920,556

(22) PCT Filed: May 16, 2006
(86) PCT No.: PCT/GB2006/001809

§ 371 Date: Dec. 29, 2008

(30) Foreign Application Priority Data
May 16, 2005 (GB) 0509833.0

(51) Int. Cl. G06K 9/00

(52) U.S. Cl. 382/133

(57) ABSTRACT

A system for performing cell population classification in respect of a biological sample. An image is captured in respect of an optical conduit array containing a plurality of cells and signals received therefrom are used to derive a classification scheme defining classes of cells. This scheme is then applied to classify the cells and data representative of the classes and respective locations in the conduit array of the cells.

This invention relates generally to cell analysis and, more particularly to a system and method for performing cell population classification in respect of a sample comprising a plurality of cells.

It is generally recognised that important technical advances in chemistry, biology and medicine benefit from the ability to perform micro-analysis of samples in minute quantities. However, making analytical measurements on minute quantities has long been a challenge due to difficulties encountered with small volume sample handling and micro-analysis of single-cell biochemistry and physiology.

In the field of, for example, compound screening, cell-based assays are run on populations of cells, and the measured response is usually an average over the cell population. However, important information is concealed by such averaging. Consider for example the calcium responses of single T lymphocytes to stimulation of cell surface receptor-type molecules by their ligang(s). Vital determinants of immune response outcome are embedded in certain types of regulatory T lymphocyte. It is known that the particular proteins controlling key gene expression activities in T lymphocytes are influenced by the pattern of fluctuation in concentration of intracellular Ca²⁺ ([Ca²⁺]ᵢ), within minutes or hours after stimulation. The intracellular calcium signals are highly heterogeneous in different individual T lymphocytes. The nature of the overall immune response in the body will be in larger part governed by the balance of activity of the classes of regulatory T lymphocytes involved in its induction. Therefore, there is a need (i) to measure responses in individual cells and (ii) to group the cells into classes with similar signal fluctuation patterns. Current technologies severely limit the quantity of useful information that can be obtained for such analysis. Although signals in a relatively small number (a few dozen) individual cells can be measured by a suitable camera-equipped microscope, grouping the cells into classes with similar signal kinetics is currently laborious even with these few cells. For many clinical, veterinary or research diagnostic purposes, it is simply not possible to simultaneously image a sufficient number of individual cells in order to perform this analysis with any statistical precision. Several thousand cells are needed for this. Not only does conventional microscopy analyse too few cells, but also cells often move their location in the image stack during the minutes or hours of recording so that usable data is obtained selectively only on the more adherent cells. Furthermore, for any cell-based assay there may be already known classes of cells that are more obvious to inspection of fluctuation patterns by the human eye, but other unknown classes may also exist that are difficult, or impossible to identify using current techniques.

Flow cytometric techniques can powerfully analyse cell-by-cell variation in fluorescence intensity of populations of single cells in suspension. Where cell populations number hundreds of thousands of cells or more, this mature though relatively expensive technology would be the method of choice. But where fewer cells are available, as in colony studies of slowly-growing clones of cells (e.g. stem cells), cell losses inevitable at the start and finish of each flow analysis restricts the usefulness of flow cytometry. Where only of the order of a thousand cells might be available or where a less expensive method is required, there is a need for an alternative technique.

We have now devised an improved arrangement, and it is an object of the present invention to provide a system and method for the automated classification of optical intensity variations in respect of large numbers (thousands or tens of thousands) of cells in cell populations comprising mixtures of different cell classes in unknown quantities.

In accordance with the present invention, there is provided a system for classification of optical intensity variations between cells in a biological sample comprising a plurality of cells of different classes, the system comprising:
means for receiving signals derived from an image captured in respect of an optical imaging conduit containing said plurality of cells within respective wells;
means for deriving a classification scheme which defines classes of cells based on one or more indicative characteristic features of said signals;
means for applying said classification scheme to said received signals to classify at least some of said plurality of cells based on the characteristic features of said received signals; and
means for providing data representative of the classes and respective locations in said conduit array of at least some of said cells.

Because the classification data is provided together with data relating to the location (or identity) of the respective cells, it is possible to effect further analysis in respect of selected individual cells or cell classes by providing classification data in one-to-one correspondence to the location or identity of each cell. For the avoidance of doubt, the optical intensity variations may originate from any permutation or combination of fluorescence, luminescence, light-scattering or absorbance intensity variations of the cells.

In one embodiment, one or more of said indicative characteristic features of said signals may be determined from light intensity variations within cell-containing regions of said optical conduit array.

In a preferred embodiment, an array of potential cell-containing regions of said optical imaging conduit is identified from said image. In the case where the optical imaging conduit comprises a coherent optical fibre bundle, for example, the array of potential cell-containing regions corresponds to a light signal received from each individual fibre of the array. An image mask, beneficially black and white, is generated to mask areas surrounding said potential cell-containing regions of said image, such that only light intensity variations occurring in the unmasked areas form the basis for said classification process.

As mentioned above, the characteristic features of said signals may be determined from the fluorescence, luminescence, light scattering and/or absorbance intensity variations within cell-containing regions of said optical imaging conduit array, and the system comprises means for receiving an optical intensity (e.g. fluorescent) image representative of said optical conduit array containing said plurality of cells.

Beneficially, for time-dependent optical intensity variations, a time-dependent curve representative of the light intensity is generated in respect of at least each cell-containing well of said optical conduit array. Preferably, said time-dependent curves are compared with a protypic signal fluctuation and a set of refined characteristics are extracted for each said curve, said characteristics defining the class of the cell contained in the imaging conduit to which a given curve corresponds.

Preferably, said system comprises a neural network trained on the characteristics of protypic signals, and the present invention extends to a method of training such a neural network to provide the means of which the system defined above consists.

In one exemplary embodiment, the system may be arranged and configured to classify the intracellular calcium response of suitably stimulated lymphocytes.

The present invention extends to use of a system as defined above to classify optical intensity variations from a biological sample containing a plurality of cells of one or more different classes.

The optical intensity variations may be time-variant or time-invariant, depending on the application to which the system is applied.

The present invention extends further to an optical imaging conduit and imaging system when used to generate said signals received by the classification system defined above. The optical imaging conduit may comprise a coherent array of optical fibres, polished at one end and etched at the other end to define respective micro-wells for holding single cells of a sample of a plurality of cells. Preferably, a digital image capture device comprising regularly-spaced light-sensitive picture elements (pixels) arranged to image said micro-wells from the polished end of said coherent optical fibre array. Said image capture device may be arranged to image said array directly or by variable optical means for altering the light path.

The cells contained within the optical conduit array may be provided with at least one external stimulus to affect the light intensity variation of one or more regions of said image of said array. However, it will be appreciated that without stimulations, optical intensity variations may occur due to naturally-occurring or to manipulated prior properties of the cells in the population.

The present invention extends to apparatus for classification of optical intensity variations from a biological sample comprising a plurality of cells of different classes, the apparatus comprising, in combination, the classification system together with the optical imaging and conduit imaging system defined above.

Once again, in one exemplary embodiment of the invention, the apparatus may be arranged and configured to obtain and classify the intracellular calcium responses to physical, chemical or biochemical stimulation of lymphocytes.

These and other aspects of the present invention will be apparent from, and elucidated with reference to, the embodiment described herein.

An embodiment of the present invention will now be described by way of example only and with reference to the accompanying drawings, in which:

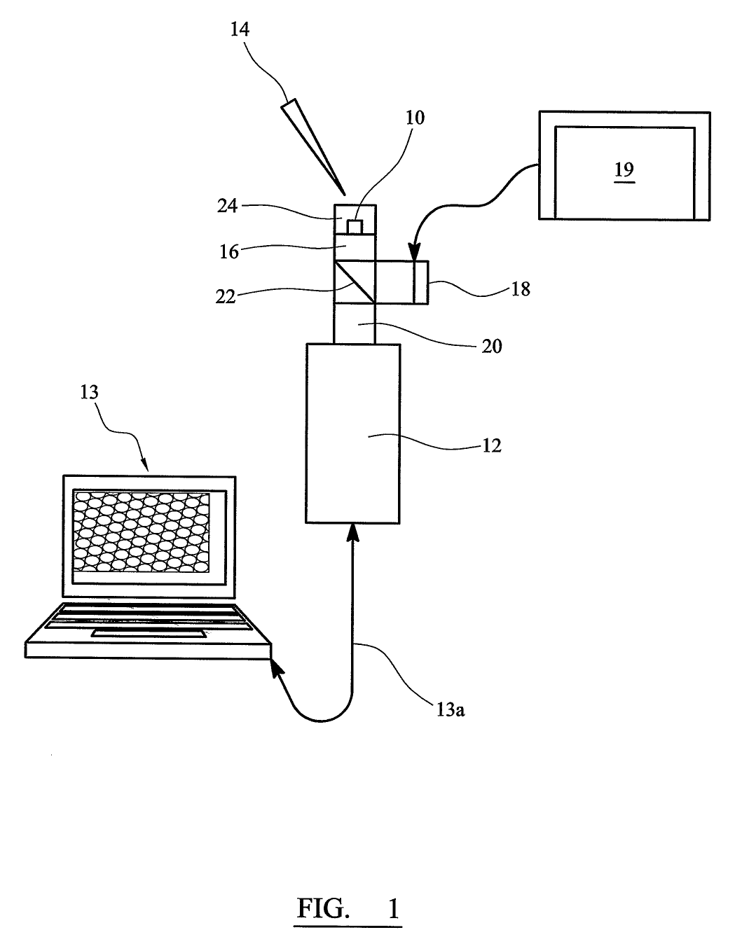

FIG. 1 is a schematic diagram illustrating the principal components of a system according to an exemplary embodiment of the present invention;

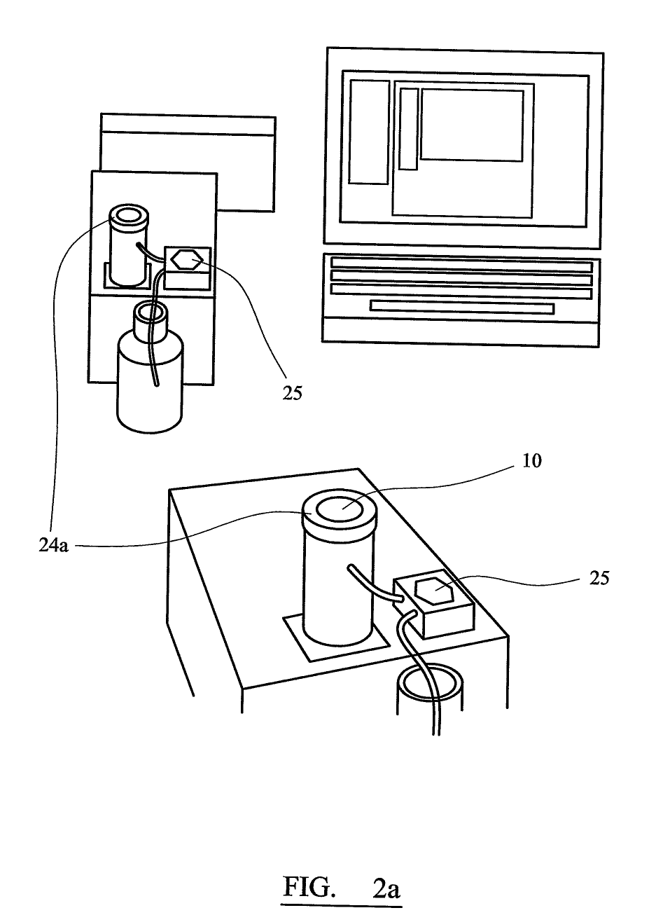

FIG. 2a is a photograph (above) and close-up (below) illustrating the general arrangement of a cell population array imager according to an exemplary embodiment of the present invention;

FIG. 2b is a schematic plan (above) and side (below) view of a suitable flow cell for use in the system of FIG. 2a, with dimensions shown in mm;

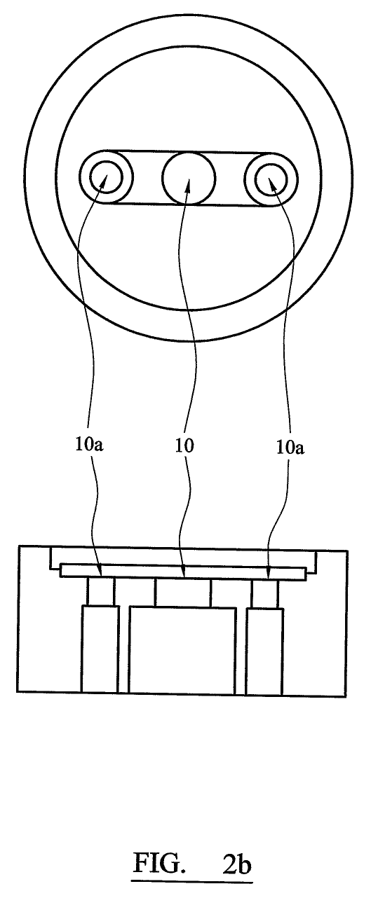

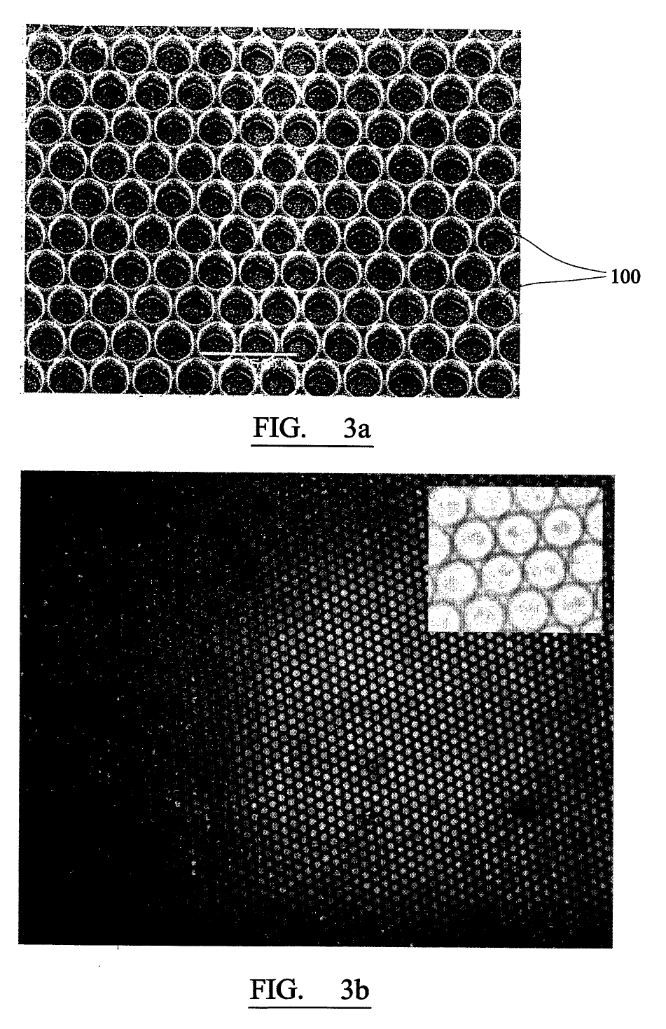

FIG. 3a is a scanning electron microscope (SEM) image of a small portion of an etched fibre conduit surface;

FIG. 3b is an image of a cell-loaded conduit (viewed through the optical fibres thereof by a CCD camera), and the inset is a low power magnified view of the cell distribution over the small portion of the conduit surface displayed by the computer screen;

FIG. 4 is a fluorescence image of the cell-loaded conduit corresponding to FIG. 3, wherein the cells show various degrees of fluorescence;

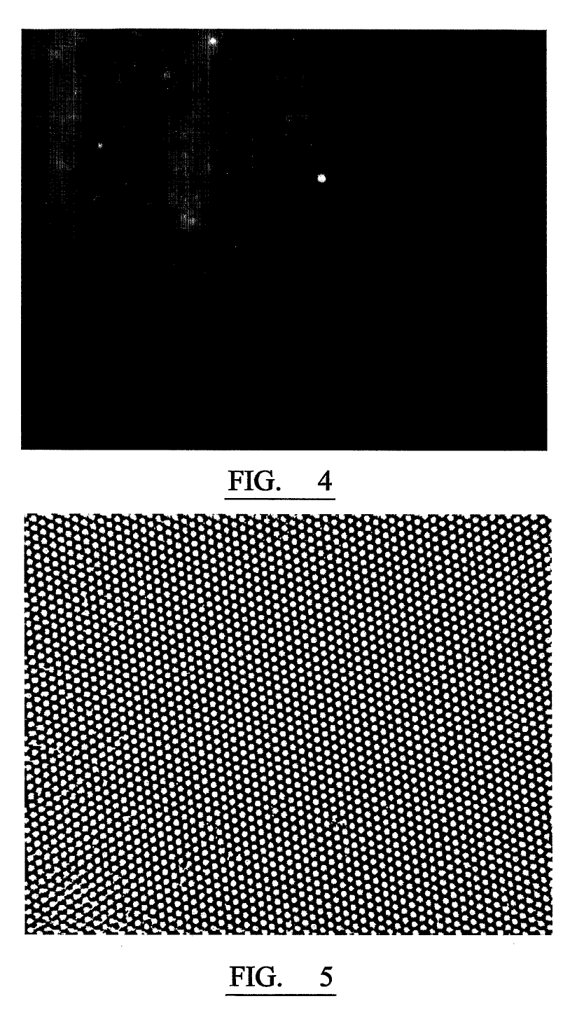

FIG. 5 illustrates a computer-generated mask used to separate signals from individual wells, the algorithm being designed to detect edges of brighter versus darker regions of an image such as that of FIG. 3;

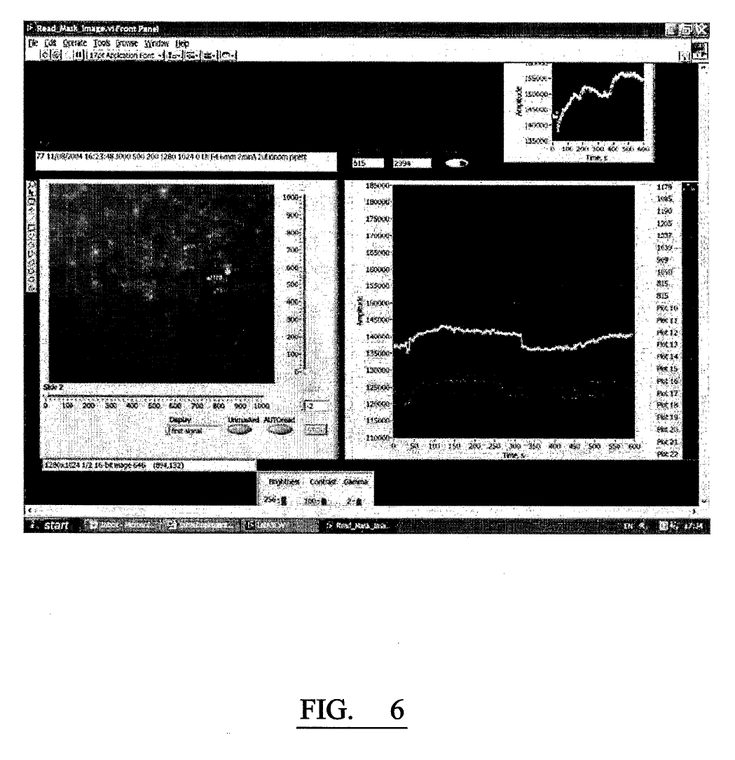

FIG. 6 is a computer screen shot generated by the signal analysis software for use in an exemplary embodiment of the present invention;

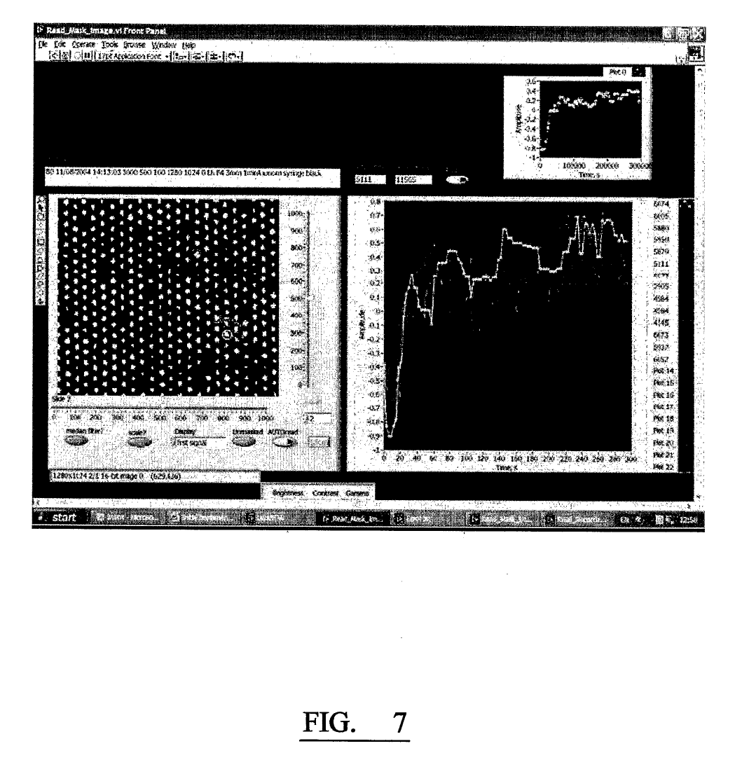

FIG. 7 is a screen shot generated by the signal analysis software of FIG. 6 in respect of lymphocyte loaded with Fluo4® and to which ionomycin as the calcium ionophore and calcium intracellular release agent has subsequently been applied;

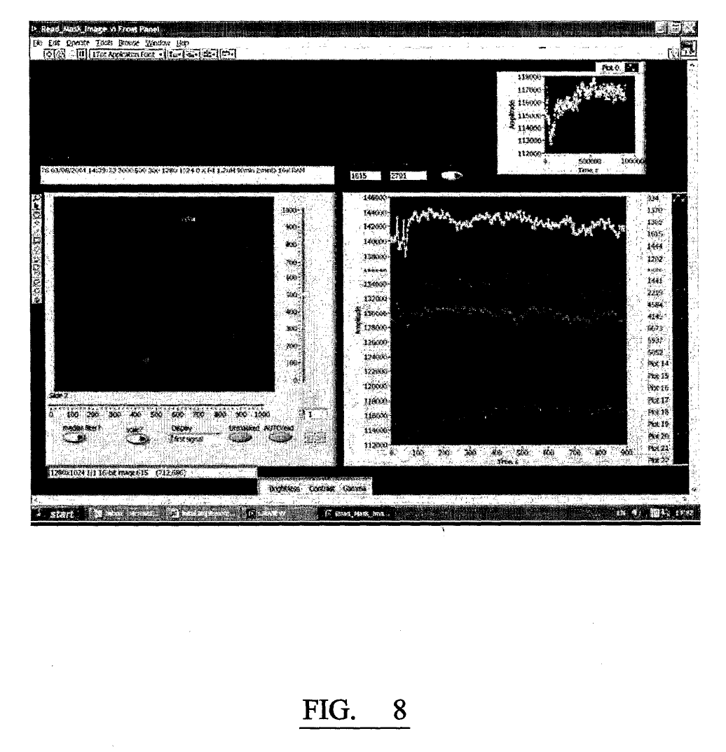

FIG. 8 is a screen shot generated by the signal analysis software of FIG. 6 in respect of lymphocytes agonistically stimulated with Rabbit anti immunoglobulin (RaMIg) antibodies to the antigen-receptor, designed to activate calcium transients in the β lymphocyte subset;

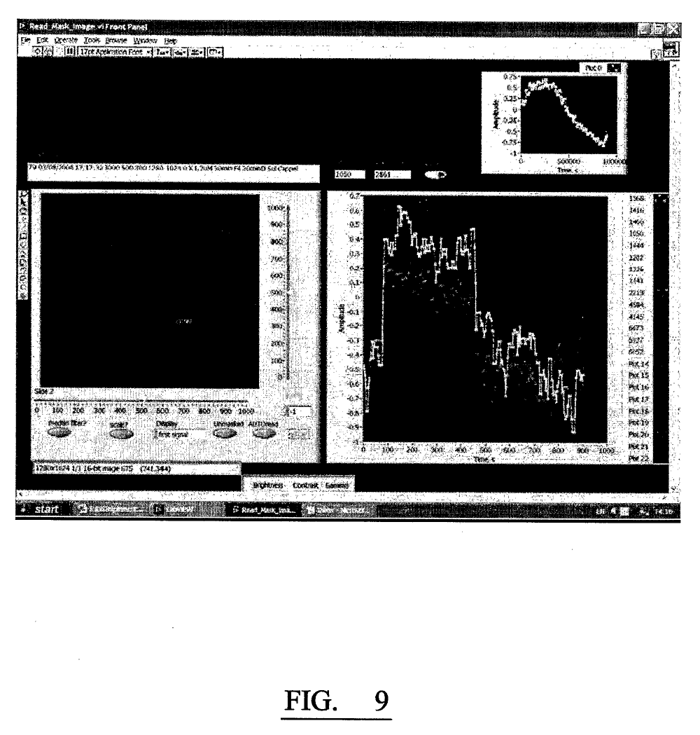

FIG. 9 is a screen shot generated by the signal analysis software of FIG. 6 in respect of the Ca²⁺ response of lymphocyte agonistically stimulated by Goat anti-Immunoglobulin antibodies to the Goat anti-Immunoglobulin antigen-receptor;

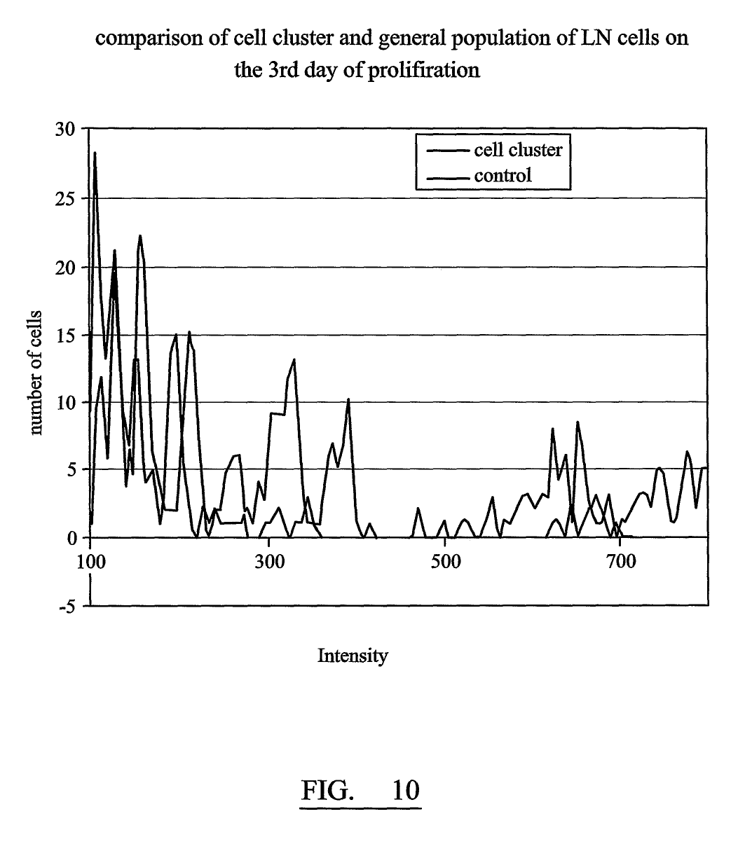

FIG. 10 is a graphical comparison of cell cluster and general population of LN cells on the 3^{rd} day of proliferation;

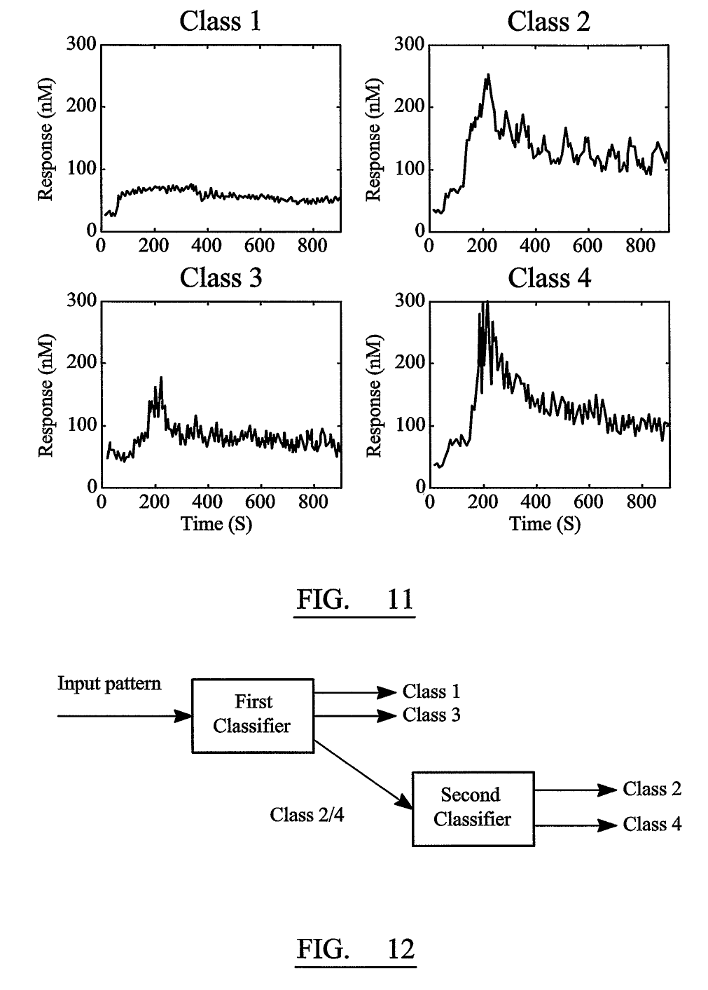

FIG. 11 illustrates fair representative examples of four patterns, manually identified by an expert, of T cell fluorescence intensity fluctuations representing calcium transients in response to agonist stimulation, this data being obtained by conventional microscopy to determine protypical characteristic features of the signals; and

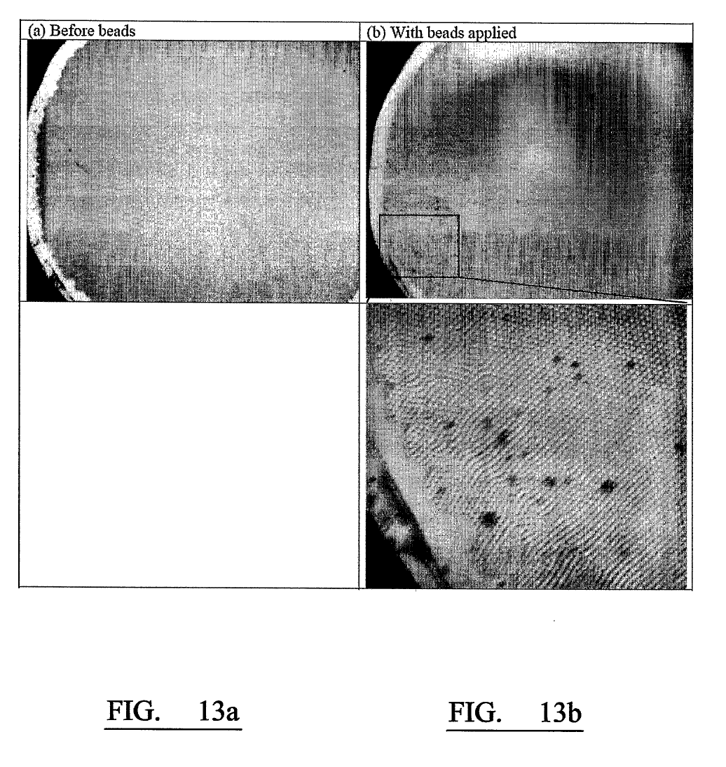

FIG. 12 is a schematic diagram illustrating the classification procedure for use in a method according to an exemplary embodiment of the present invention;

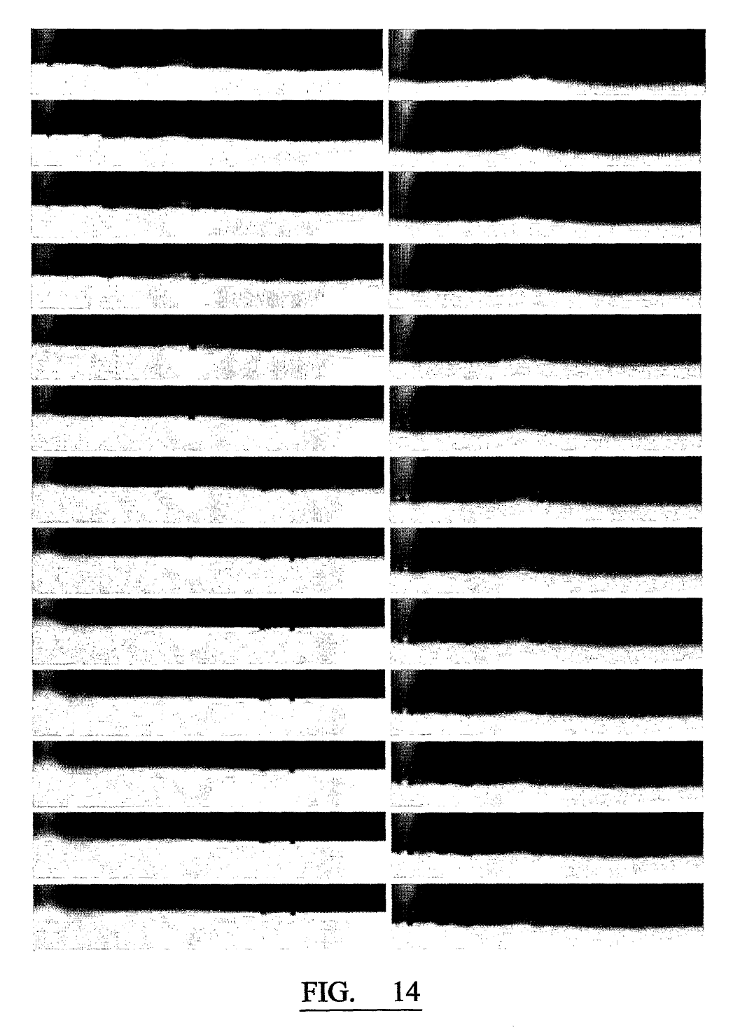

FIG. 13 are microscopic photographs illustrating the use of standard DVB-latex particles to check well depth: application of beads—FIG. 13a depicting the case before bead application and FIG. 13b depicting the case after bead application; and

FIG. 14 is illustrative of stepping through the vertical plane of a conduit face edge on, loaded with calibrating beads.

Referring to FIG. 1 of the drawings, there is illustrated schematically an exemplary configuration of a system according to the invention. An optical conduit 10 is provided which comprises an array of tens of thousands of microwells with an overall diameter of a few millimetres, which is about the same as the dimensions of a typical CCD camera 12. In this case, the camera 12 may be, for example, a 1280×1024 cooled CCD camera, but it will be appreciated that many different types of pixellated imaging means may be used, and the present invention is not intended to be limited in this regard.

In this exemplary embodiment of the present invention, a fibre-optic conduit 10 containing tens of thousands of regularly-spaced fibres bundled in an array. Controlled etching of the polished surface of the conduit creates micro-wells 100, as shown in FIG. 2 of the drawings. A method for checking the extent of etch and, therefore, the depth of the wells is described below in the section entitled “Monitoring the depth of etching”.

These micro-wells 100 are used isolate and hold single cells of a sample applied to the conduit 10. Each micro-well typically has a depth of a few microns and a diameter of the order of 10-25 microns. The distal, plane-polished (non-etched) end of the conduit is imaged by the cooled CCD camera 12, controlled by a computer 13 via a data interface (denoted at 13a). The optical system for effecting such imaging comprises a microscope objective 16, an LED light source assembly and interference filter (denoted at 18) supplied by a regulated power supply 19 (e.g. 1-2 Ampere), a fluorescence interference filter 20, a dichroic mirror 22, and a conduit holder and focusing stage (denoted at 24). A short length of silicone tubing (not shown) surrounds the proximal (etched) end of the conduit to confine a cell buffer solution, and a microlitre pipette 14 is used to deliver a biochemical reagent such as antibody.

Referring to the relative arrangement of FIG. 2a of the drawings, a flow cell 24a, imaging conduit 10 and pump 25 of a cell population array imager according to an alternative exemplary embodiment of the invention can be seen. In this case, an alternative means for holding the conduit such that reagents can pass across the etched face of the conduit in a small enclosed flow chamber is proposed wherein, rather than applying them manually to an open conduit, the ends of a narrow inlet 10a and outlet tube 10b are arranged across a diameter of the conduit 10, as illustrated in FIG. 2b. Fluids are pumped by the computer-controlled variable rate peristaltic pump 25. All operations, including cleaning the conduit 10, introducing the cell suspension, and adding a succession of chemical and biochemical reagents, are controlled by stopping and starting the flow. The inlet tube 10a is connected to a sipping tube which can be manually transferred, while flow is stopped, from one appropriate sample tube to the next. The dimensions of a suitable flow cell (or flow chamber) are illustrated in FIG. 1b, although it will be appreciated by a person skilled in the art that the present invention is in no way intended to be limited to the illustrated dimensions.

In a method according to an exemplary embodiment of the invention, live cells (for example, lymphocytes) are loaded or stained with an appropriate fluorescent dye according to the manufacturer's recommended protocol. For example, if the calcium response of the lymphocytes is required to be measure, a fluorescent dye supplied by Molecular Probes under the name Fluo4® (AM ester) might be used.

An etched optical fibre conduit is cleaned by means of a standard protocol, described below in the section entitled “Cleaning the optical surfaces of the conduit, and filled with an appropriate physiological buffer. The conduit is then centrifuged at about 450×g for ˜5 min to remove any air bubbles that might be trapped in the microwells. A small aliquot of cell suspension, typically containing about 50,000 cells, is added to the buffer solution, covering the etched end of the conduit. The conduit is centrifuged for under 1 min at about 450×g to help cells settle individually into the microwells. Alternatively, within the flow cell method of conduit mounting, stopping the fluid flow holding a cell suspension at 7×20×10⁶ cells per mL permits cells to settle under gravity for 10 to 15 minutes.

A cell-loaded conduit is then inserted into the conduit holder and a focused image of the microwells is obtained, such as that shown in FIG. 4. This image is recorded and processed by the proprietary software to generate a black and white image mask, such as that shown in FIG. 5, where the cell-containing regions are unmasked and the surrounding area is masked so that any light intensity variations coming from the masked areas are ignored. Each unmasked region is assigned a unique reference number (referred to hereinafter as the well number).

The cleanliness of the ends of a demounted conduit is checked by low-power light microscopy. No significant surface matter should be seen. Within the flow-cell, the surface is checked under the same conditions of fluorescence illumination and recording as used in the experimental procedure. No significant fluorescence should be seen, though if a stubborn residue remains its presence can be noted photographically and allowed for at the time of analysis.

Using lymphocytes or erythrocytes as typical non-adherent cells, well depths in the range 5 to 7 μm prevent nearly all cells from being dislodged at the slow fluid flow rates employed to pass reagents over the conduit face 6 μL per min). This corresponds to the standard beads being three-quarters-buried (one quarter protruding). Etching times are adjusted to yield a suitable depth. About 8 minutes of exposure to etchant produces a depth of about 6 to 8 μm.

A LED assembly is powered up by switching the power supply. The light from the LED passes through a short-pass interference filter that removes at least longer wavelengths than the fluorescent dye excitation wavelength. Next it is reflected by the dichroic mirror, which further filters the LED light, towards the microscope objective. The microscope objective focuses the LED light at the plane of the distal (non-etched) end of the conduit. The light travels up the fibres of the conduit and excites fluorescence in the dye labelled cells in the microwells. The fluorescence intensity may change in response to the applied external stimulus (e.g. ionomycin in case of Ca²⁺ concentration can be used for test purposes). Some of this fluorescence returns down the conduit, passes through the microscope objective, then the dichroic mirror and another long-pass interference filter that is transparent only to the fluorescence but blocking the excitation. Finally the fluorescent signal is detected by the CCD chip at the focal plane of the microscope objective. The resulting fluorescent image (FIG. 4) is transferred to the computer via a data interface.

The user selects a camera exposure time suitable for the range of fluorescent intensities, chooses the number of frames to be taken and a time interval between frames, and then starts the acquisition. A stimulus delivered from, for example, a microlitre pipette can be added several frames after the start of the acquisition. Each fluorescent image is masked (FIG. 5) and the integral light intensities from each individual fluorescent well are recorded. A time dependence of the fluorescent intensity is saved for each well that contains a cell as a separate curve. An example of such curves is illustrated in FIG. 6.

The obtained time-dependent cell fluorescence curves are further compared with a model signal response and a set of parameters is extracted for each curve. These parameters are used to classify the curves with the help of a pre-trained neural network, an example of which will be described in further detail below. As a result, the initial population of cells on the conduit is subdivided into several classes in accordance with their response to the stimulus. The change in the ratio of the different subclasses or appearance of the new ones might serve as a diagnostic tool in medicine. The type of the cells in subpopulation can be later confirmed or identified by the subsequent dye staining or antibody marking. Other cell properties after time-course data capture is complete can be checked, e.g. by staining for DNA content to confirm that a well contains just one cell.

### Monitoring the Depth of Etching

A crucial variable in the successful use of the optical conduit is the depth of the wells. If too deep, the reagents cannot access the cells; if too shallow, cells are flushed from the wells by the fluid stream in the flow chamber. The depth must be optimised and checked as part of the quality control for their production. Well depth can be definitively measured by scanning electron microscopy (FIG. 2) of the conduit surface after coating with heavy-metals by standard shadowing techniques. However this is a destructive method since it renders the wells opaque. The preferred method for routine checking is non-destructive. A small number of uniformly sized beads are placed on the etched surface in an ultramicrodroplet and surplus liquid is removed by evaporation. By inspecting how far they protrude above the surface when viewed edge-on (laterally) the approximate depth can be estimated, knowing the bead diameter. The beads can later be removed by standard cleaning protocol described below.

### Process

In an exemplification of this analytical method, polystyrene DVB-latex beads of mean diameter 8.79 μm (Coulter Electronics, part 9966067) are suspended in 100% EtOH ultrafiltered through a 0.22 μm filter to remove contaminant particles (final 0.5×10⁶ per mL). 0.1 μL is applied to the perimeter of an etched conduit and the solvent is evaporated. The distribution of the beads (normally 20-50 of them) is inspected with the conduit en-face under low-power objective to check for aggregates and for beads not settled into wells. (See FIG. 13, FIG. 13a: before bead application; FIG. 13b: after bead application). The etched surface is then rotated through 90° to visualize the bead protrusions. By z-stepping manually through each of a dozen or so beads a visual indication whether a bead is typically fully buried, three-quarters-buried, half-buried, quarter-buried or flush on the surface can be obtained (See FIG. 14).

### Cleaning the Optical Surfaces of the Conduit

For the present, the conduit must be re-used and is not disposable. A method for cleaning the surface has been developed. A conduit is removed from its mount for rigorous intermittent cleaning but for cleaning between each sample over a few runs (for instance half a dozen consecutively) the conduit is left in place. The cleaning reagents are the same in each case but demounted conduits are additionally centrifuged to spin away microparticles from their optical surfaces.

A cleaning cycle consists of exposure of the conduit face to the following in succession:
1. Cell suspension buffer alternating frequently with air (as bubbles through the flow chamber; or as a jet played on the demounted conduit);
2. Concentrated hydrogen peroxide solution;
3. A proprietary glass-cleaning solution comprising wetting agents, emulsifiers, ampholytic surface-active agents, complexing agents and potassium phosphate (Hellmanex® II at the recommended working strength).
4. Several cycles of cell suspension buffer, ultrafiltered to 0.22 μm.

The etched end of the conduit is kept under liquid at all times. The non-etched end is dried by a cycle of ultrafiltered deionised water (several rinses), ultrafiltered 100% EtOH and drying in ultrafiltered air.

A demounted conduit is centrifuged under the glass-cleaning solution at the finish of stage (3) at 1600×g for 5 minutes to detach microparticulate material. After one centrifugation, the conduit is reversed, the spun end is protectively covered and the conduit is inverted for re-centrifugation to clean the other end.

It will be appreciated that the principle of arrayed populations of individually-addressable cells described above can be implemented in a variety of different ways. Several important parts can be identified that could make CPAI into a unique research and diagnostics instrument.
Alternative arraying constraints or devices. First of all, an optical conduit with etched microwells is used to separate individual cells but keep them very close to each other, with an optical light-guiding being an additional advantage. The choice of fibre optic cable may vary depending on the cells to be analyzed, i.e. the size of the optic cables in the bundle determine the size of the microwells, which can be matched to the size of the cells to be analyzed. The etched conduit could be replaced for example with a micro-channel glass plate, a Cyclopore® track-etched membrane, or a glass or plastic slide with a regular pattern of spots or lines that are printed, etched or defined using photolithography. The pattern elements could be made specifically attractive to individual cells by coating the floor of the pattern element with a particular ligand, e.g. a macromolecule such as an antibody against the cell surface. Or, in another implementation, those elements could repel cells or prevent their adhesion.
Biochemical or other manipulation of cells before analysis. Preincubation under defined culture conditions before data is captured can be envisaged. A system supporting normal living conditions and controlling cell culture temperature and CO₂ concentration can be added.
Stimulus presentation. In the description above, the biochemical stimulus is added to all cells uniformly to the entire arrayed cell population, as a reagent in solution. But a range of stimuli could equally well be arrayed by a robotic applicator one at a time into each microwell prior to the experiment. Surplus ligand would be washed off so that all ligand was surface-attached. Cells in suspension would then be introduced and sink onto the surface. The contact with the coated surface would initiate the response. Such an arrangement would be very suitable for screening large numbers of ligands such as can be generated by modern proteomic approaches, against a homogeneous test cell population. This approach would require the physical location of each microwell to be matched to the software-generated address generated by the masking algorithm.
Physical stimuli. A mechanical or electromagnetic stimulus can be used on a par with chemical or biochemical stimulation.
Alternative signals. Luminescence, light scattering or absorbance can potentially be used as signals instead of fluorescence. With luminescence, no illumination is needed and the instrument acts as a passive recording instrument. Many cell biological transfection experiments used luciferase reporter gene constructs which generate luminescence, either analytically, or as selection tools to enrich for high expression of a gene transcript. Rare high-expressors could easily be scanned for and identified, and in conjunction with a retrieval micromanipulator, individually physically addressable to a particular microwell, it would be possible to select and clone high expressors.
Alternative detector chips. The CCD chips in most present-day cameras use doped silicon as the substrate. A CMOS or another array of light-sensitive elements can be used for signal detection. Advanced CMOS technology holds the promise of individual amplifiers under each pixel making the detector much more light-sensitive with pixel-to-pixel reproducibility. As ever more sensitive chips are developed, with higher resolutions, it may even be possible to measure internal compartmentalization of factors within each cell (i.e. cell trafficking in a high throughput manner).
Bringing the light from the array to the solid-state device. With suitable spacing and geometric arrangement, the cell holding array (e.g. conduit) could be imaged or directly attached to the surface of the CCD chip. Moreover, a dedicated detector chip (CCD or CMOS) containing microwells etched into its surface could potentially be produced.
Illumination. LED light source can be replaced by a laser, UV lamp or a monochromator. Additional optical elements like shutters or filter wheels can be added to increase functionality or flexibility of CPAI. A fluorescent optical microscope equipped with a digital camera can potentially be converted into CPAI. The epifluorescent illumination used in this example can be replaced or supplemented by top or angled illumination.
Classification software. The classification part of the software can be implemented via neural networks or other suitable algorithms that allow categorizing information, for example using decision trees, or nearest neighbour algorithms.
The essence of the above-described embodiments of the present invention is achieved using a combination of physical means of arranging single live cells into a tightly-packed array of individually-addressable elements, a detector simultaneously registering signals from large numbers of individual cells (thousands or tens of thousands simultaneously), with software that (i) collects time series or spatially patterned parallel cell signalling and then (ii) performs automated signal classification.

An exemplary embodiment of the present invention, illustrating a pre-trained neural network specifically for automated classification and analysis of the calcium response of single T lymphocytes, will now be described in more detail.

On stimulating T cells, a variety of different [Ca²⁺]ᵢ response patterns are observed in individual cells. These patterns are determined partly by the type of stimulus, partly by the concentration of the stimulus and partly by the phenotype of the cell. The calcium signal is a highly important regulator of gene activation, for example in human T cells 111 genes were shown directly to be calcium dependent, with 79 being up-regulated by increased calcium and 32 being repressed. However, calcium signal is more subtle than a simple on-off switch as has been shown by studies of the spatio-temporal changes in [Ca²⁺]ᵢ signal at the single cell level. In single B cells, a high, but transient, rise in [Ca²⁺]ᵢ has been associated with preferential activation of NFκB and JNK whilst a lower sustained rise in [Ca²⁺]ᵢ induced nuclear translocation of NFAT and ERK. A tight coupling between oscillatory activation and translocation of protein kinase C and calcium oscillations suggests a number of other pathways may be affected by the quality of the calcium signal. Whether the pattern of [Ca²⁺]ᵢ signal leads to the differential activation of transcription factors in T cells is less clear but there is some suggestion that this is the case since stimuli that give rise to proliferative responses are associated with a sustained but modest increase in [Ca²⁺]ᵢ but not with a transient increase in individual cells.

Differential activation of transcription factors may result from the different calcium signals in T cells, since this was demonstrated in B cells, and there are strong suggestions that the patterns of calcium response regulate transcriptional activators differently in Th1 and Th2 T cells resulting in their contrasting cytokine expression. In human pathologies the distribution and responses of T cells may be perturbed. For example, we have demonstrated a decreased calcium signal in both peripheral blood and synovial T cells in rheumatoid arthritis which relates to the decreased functional responses of the T cells. Further analysis of T cells from the joint has shown that there is an increase in the number of T cells giving an oscillatory calcium response as well as in those giving no response. In this study, based on a strategy proposed by others, four characteristic types of response of T cells to stimulation with mitogen phytohaemagglutinin were identified by manual scrutiny of the traces, as shown in FIG. 11:
(1) non-response (does not exceed a threshold, currently set by experience);
(2) oscillating response (shows recognisable periodicity in amplitude during decay phase);
(3) transient response (returns promptly to near baseline);
(4) peak-plateau response (decay more prolonged than type 3, but no discernible oscillation).

Currently a trained expert allocates the time series relating to the response, which is based on measuring fluorescence intensity, of each individual T cell to one of these four classes. Clearly the classification is based on the expert's opinion and experience. This is prohibitively costly of both time and labour and cannot deal with tens of thousands of cells as would be desirable in future. Since the data from so few cells, hundreds at most, can at present be processed, rarer classes cannot be identified that perhaps should be additionally introduced. We present here an automated classifier that was first trained on a subset of already-classified data. It was then tested by applying the algorithm to the entire data set and comparing its outcome against the manual classification. Although the responses shown in FIG. 11 are distinct from each other, it should be noted that a large proportion of the examples are much less clear and there is considerable variation within the classes, which makes this classification a non-trivial problem.

### EXAMPLE

### Separation of T Cell Subsets

Peripheral blood mononuclear cells were prepared from healthy volunteers using centrifugation on Ficoll-Paque. After a 1 hour adhesion at 37° C. on a HIFCS-coated Petri-dish, non-adherent cells were depleted of non-T cells using a cocktail of antibodies (against CD45RO, CD8, CD11c, CD14, CD16, CD19, glycophorin, HLA-DR and TCRγδ) and magnetic beads. This negative selection procedure was repeated 3 times to achieve a CD4⁺CD45RA⁺ cell preparation of >95% purity. Gamma-irradiated (3000Rad) EBV-transformed cultured B lymphocytes from the same individual were added into the initial culture at a ratio of 1:10 (EBV transformed B cells: T cells), T cells being included at a density of 0.25×10⁶/ml. The culture medium consisted of RPMI 1640 with 2 mM glutamine, 100 units/ml penicillin, 100 μg/ml streptomycin, 1% sodium pyruvate, 1% non-essential amino acids, 1% HEPES and 5% human serum. PHA at a concentration of 1 μg/ml was added as the initial stimulus to the culture. To maintain the culture, 25 units/ml of recombinant human IL-2 were added on day 4 of the culture and cells were fed with fresh medium on days 7 and 11. On day 14, cells were removed for measurement of [Ca²⁺]ᵢ. The viability of the cells was checked using the TRYPAN-BLUE dye exclusion test, showing that more than 90% of cells remained alive during the process. The cells were also packed sufficiently loosely for stimulation of cells by neighbouring cells not to be a problem.

### [Ca²⁺]ᵢ Measurement by Single Cell Ion Imaging

T cells were loaded with 2 μM Fura-2 AM (Molecular Probes) for 30 minutes at room temperature. The cells were then washed 3 times and re-suspended at a final concentration of 10×10⁶/ml. Ten micro-litres of Fura-2 loaded cells were allowed to settle on one well of a poly-D-lysine coated 8-welled coverslip (Nunc) for 10 minutes at room temperature. Cells that had not adhered were gently washed off and HBSS (250 μl) was added. In a dark room, the slide was placed on the stage of an inverted fluorescence microscope and the cells brought into focus at a magnification of 500×. A field with a large number of cells was chosen for analysis. Fura-2-loaded cells were excited at 340 nm and 380 nm and images were collected at a rate of one pair every 4 seconds, the readings of fluorescence emission being collected at 510 nm. After allowing a baseline measurement of [Ca²⁺]ᵢ to be collected for 60 seconds the cells were stimulated with 10 μg/ml of phytohaemagglutinin (PHA)-P by adding a volume of 250 μl Ca²⁺ HBSS containing 5 μg PHA-P.

The single cell imaging system (IonVision, Improvision, Warwick, UK) was calibrated using solutions containing a known [Ca²⁺] with 2 μM free Fura-2. Background images (collected from a region where no cells were present at both 340 nm and 380 nm) were subtracted from the experimental images and ratio images were created using the IonVision III software. A region of interest was drawn around each individual cell and the concentration of calcium in each cell at each time point was calculated using the IonVision software. This data was transferred into a Microsoft Excel spreadsheet and the [Ca²⁺]ᵢ plotted against time for each individual cell. The [Ca²⁺]ᵢ responses were categorized as peak-plateau, oscillating, transient or non-responding as we have described previously using a similar classification systems to that used by others and as described earlier. The process took one trained expert a couple of hours for over 800 traces. This was done in one sitting to prevent differences in classification on separate occasions.

### Data Pre-Processing and Feature Extraction

The data set derived using the methods outlined in the previous section comprises a set of 823 time series, irregularly sampled at approximately 0.3 Hz. The irregular sampling is due to hardware restrictions and does not have a significant impact on the data: typical sampling values are a mean of 3.01 seconds and standard distribution of 0.24 seconds. A spline-type interpolation was used to re-sample the data with a time period of 3 seconds to ensure that each section of the time series is of equal importance. The initial and final sections of the time series are then removed to avoid edge effects. The distribution of data samples within the classes is shown in Table 1. There are many more examples of the second and fourth categories than there are of the first and third. The difficulties that this poses are addressed later, when considering the type of classifier to be used and when training the classifier.

| Non- | Oscillating | Transient | Peak-plateau | |
|---|---|---|---|---|
| response | response | response | response | Total |
| 32 | 238 | 28 | 525 | 823 |

Table 1 Distribution of Data Samples within Classes

The time series is then compared to a delayed second order model of the response:

y=y₁+(y₂(e^{-(t-t}^{₁}^{)/τ}^{₂}−1)+y₃(e^{-(t-t}^{₁}^{)/τ}^{₃}−1))H[t−t₁],

where there is a baseline value y₁ with a second order response starting at t₁, hence the use of the step function H. The example traces in FIG. 11 show that there is an initial step in the response at approximately 50 seconds: this is an artifact and is removed by simply considering the time series after a time of 75 seconds. This also simplifies the analysis, since fewer parameters have to be included in the model response if this initial step is not included.

We then assume that there is independently distributed Gaussian noise on the signal in each model:

zₙ=yₙ+εₙ,

where the noise has zero mean and variance σ_{M}². There are thus six parameters that determine the model behaviour, [y₁, t₁, y₂, τ₂, y₃, τ₃,], together with the noise variance. In addition, we include the mean, y̅, and variance, σ², of the time series, thus giving nine parameters in total.

We use a method of parameter estimation that calculates these parameters for each time series for both models within a principled Bayesian framework. This framework is based on maximising the joint likelihood, which enables priors on the model parameters to be specified. Maximising the joint likelihood p(Z|θ)p(θ), where the first term denotes the probability of the data,

$$p ( Z ) = {\prod }_{n} p ( {z}_{n} ) ,$$

given the model parameters, θ, and the second the probability of the model parameters, is equivalent to maximising the conditional probability of the model parameters given the data set, by Bayes' theorem. To find the optimal model parameters given the data set, we maximise the joint likelihood, or more commonly, the log of the joint likelihood:

Q=log(p(Z|θ)p(θ))=log p(Z|θ)+log p(θ).

We set Gamma priors on all the model parameters. The model parameters are all normalized with respect to the most likely values, which have been estimated from considering a large number of patterns. This enables Gamma priors to be used, as they are more analytically tractable. The advantage is also that the model parameters must be positive, which is enforced by use of a Gamma distribution: this is thus more physically realistic. We implicitly assume that the parameters are independently distributed. Gamma priors are also used on the noise variances and Gamma hyper-priors are then set on the model and variance priors and the priors integrated out, giving:

$$Q = log p ( Z \vert θ , B ) + {\sum }_{k = 1}^{K} log [ {\int }_{{A}_{k}} p ( {θ}_{k} \vert {A}_{k} ) p ( {A}_{k} \vert {B}_{k} ) d {A}_{k} ] ,$$

where Aₖ=[aₖ, bₖ] (the priors), Bₖ=[αₐₖ, βₐₖ, α_{bk}, β_{bk}] (the hyper-priors) and there are K parameters in the model. The differential of Q with respect to each parameter thus becomes:

$$\frac{\partial Q}{\partial {θ}_{k}} = \frac{1}{2 {σ}^{2}} {\sum }_{n = 1}^{N} [ ( {z}_{n} - {y}_{n} ) \frac{\partial {y}_{n}}{\partial {θ}_{k}} ] + \frac{[ {\int }_{{A}_{k}} \frac{\partial p ( {θ}_{k} \vert {A}_{k} )}{\partial {θ}_{k}} p ( {A}_{k} \vert {B}_{k} ) d {A}_{k} ]}{[ {\int }_{{A}_{k}} p ( {θ}_{k} \vert {A}_{k} ) p ( {A}_{k} \vert {B}_{k} ) d {A}_{k} ]} .$$

All the hyper-prior values are set to one, to ensure that the distribution is centred upon one, since the parameters have all been normalized relative to the most likely values.

The parameter estimation procedure is then an iterative process:

$${\hat{θ}}_{k} = {θ}_{k} + η \frac{\partial Q}{\partial {θ}_{k}} .$$

However, the updated parameter is only accepted if Q increases for the updated value. The parameter η is initialized to a small positive value and then adjusted dependent upon acceptance or rejection of the new value: if it is accepted, increase by a factor kᵤₚ, if it is rejected, decrease by a factor k_{down}. Values of 1.2 and 0.1 respectively are suggested. Since it is likely that changing some model parameter values will increase Q, but that others will not, only those parameters that increase Q will be updated, the rest remaining the same. Any standard convergence test can be used on Q to stop the iterations as desired. The noise variances are updated in parallel with the model parameters. The normalized model parameters are initialized to one and the variances to 50.

### Frequency Analysis

Examples from the second and fourth classes will clearly be found to be very similar using this model-based approach, since the second class is characterised by the same underlying response as the fourth class, but with an oscillating component superimposed. Once the delayed second order model has been fitted to the time series, the difference between this and the time series in the period from 75 seconds to 575 seconds from the beginning of the second order response is thus analysed in the frequency domain. The frequency analysis is performed using an Auto-Regressive (AR) model in order to provide a smooth frequency spectrum. The Yule-Walker method is used with a model order of 50. Three parameters were extracted from the resultant power spectral density distribution for each pattern: the maximum power (in arbitrary units), the corresponding frequency (in Hz) and the total power in the band 0.008 Hz to 0.0125 Hz (again in arbitrary units). This range corresponds to a time period between 80 seconds and 125 seconds: chosen since the oscillations identified by the expert appeared to have time periods within this range.

There are thus a further three frequency-based features extracted from each time series, in addition to the nine time-based parameters outlined earlier, of which one is discarded for reasons discussed previously. The remaining eight time-based parameters from the model are used to distinguish between classes 1, 3 and 2 together with 4: the last two being separated by means of the three frequency-based parameters. All the features were normalized to zero mean, unit variance to ensure that no single feature dominated the behaviour of the classifier.

### Training of Classifier

The primary difficulty with training an automated classifier on the data available here is the limited availability of examples for the first and third classes. Training a classifier with such a small number of examples is well known to be difficult. We decided that a Neural Network (NN) approach was the most promising, as it is good at finding complex boundaries between classes of patterns in high-dimensional spaces from data sets and is capable of generalisation using a relatively small number of parameters (14). However, a NN requires approximately equal numbers of training patterns from each class, which is difficult given the relative occurrences in Table 1. We thus decided to split the classification into two stages.

The first stage treats classes 2 and 4 as a single class and classifies the input patterns according to classes 1, 3 and 2 combined with 4. The second stage then only classifies those patterns identified as belonging to this joint class according to classes 2 and 4 respectively, FIG. 12. The classes are divided in this way as the most similar patterns are those belonging to classes 2 and 4, whereas classes 1 and 3 are more dissimilar.

The length of the target or output vector is equal to the number of classes under consideration, i.e. 3 in the first network and 2 in the second, where the output is 1 when the pattern belongs to that class and 0 otherwise. This sets the value of K. The outputs thus provide an estimate of the posterior probability (14): however, when the relative proportions of the classes used for training the NN is different from the actual proportions, i.e. the training set class probabilities are different from the actual class probabilities, a correction must be applied to the output. We implicitly assume that the real relative class sizes correspond directly to the proportions of examples in the data set that we used here: however, this can easily be adjusted if necessary without having to retrain the networks. The maximum output value is used to assign a pattern to a class. We use logistic sigmoid units and train the networks using the Quasi-Newton algorithm and the BFGS method. It was decided to use regularization rather than a validation set to determine the optimal network parameters.

### First Network

To keep the number of weights as low as possible in the first network, both the number of features and the number of hidden nodes must be kept to a minimum: we now consider both of these in turn. For the first network, the frequency information is not relevant, since we are grouping classes 2 and 4 together. The key features that distinguish class 1 are the small change in the signal over time and the lack of a distinguishable peak. Class 3 is characterised by a return to baseline, despite a peak in the time series, whereas classes 2 and 4 do not return to baseline. The second order model response can be used to derive expressions for the maximum value and the final steady state value, relative to the original value in the time series. This gives two new features: (Δy)ₘₐₓ, i.e. the maximum change in the time series, and (Δy)_{final}, i.e. the final steady state change in the time series. The variance of the time series is taken to be the third feature for use in the first network, since this provides a measure of the deviation from baseline of the time series.

If half the numbers of patterns in classes 1 and 3 (16 and 14 respectively) are chosen for the training set, together with a similar number (15) from each of classes 2 and 4, a total of 60 training patterns can be used. The patterns were selected from the complete set at regularly-spaced intervals of a size such that the relevant numbers of patterns were found, i.e. every second example in classes 1 and 3 and every 16^{th} and 35^{th} example in c lasses 2 and 4 respectively.

For three input and three output nodes, the number of weights is W=7J+3. An upper limit for the number of hidden nodes would thus be four, giving 32 weights (a ratio of approximately 2:1 in number of patterns to number of weights), although three hidden nodes would give a ratio of closer to 3:1.

We used a regularization of the form:

$$\tilde{E} = E + α \frac{1}{2} {\sum }_{l} {w}_{i}^{2} ,$$

i.e. the error function plus a penalty term, proportional to the sum of the squared weights (14). This second term discourages large weight values and thus rewards simpler mappings. The choice of the regularization parameter is clearly important: too small a value will lead to over-fitting of the training set and thus poor generalisation, whereas too large a value will give a poor fit to the training set as well as poor generalisation. Essentially, this penalty term is equivalent to including a prior on the network weights that penalizes large values, similar in style to the priors included on the model parameters outlined earlier. A value of 0.05 was selected as providing an acceptable balance between good generalisation and over-fitting.

The network was then trained a number of times with different random initializations, and the solution with the smallest error selected as the final trained network. The results on both the training patterns, the remainder of the data set and the entire data set are shown in Tables 2a, 2b and 2c below. The accuracies of the three data sets are 83.3%, 89.3% and 88.8% respectively.

TABLE 2
Results of first trained network: (a) Training set;
(b) Remainder of data set; (c) Entire data set

| | | Predicted class | | |
|---|---|---|---|---|
| | | 1 | 2 | 3 |
| Actual | 1 | 10 | 6 | 0 |
| class | 2 | 0 | 30 | 0 |
| | 3 | 1 | 3 | 10 |
| Actual | 1 | 8 | 6 | 2 |
| class | 2 | 3 | 667 | 63 |
| | 3 | 2 | 6 | 6 |
| Actual | 1 | 18 | 12 | 2 |
| class | 2 | 3 | 697 | 63 |
| | 3 | 3 | 9 | 16 |

### 3.3.2 Second Network

The second network was trained in a similar fashion, but with half of the examples of class 2 and one quarter of class 4: 119 and 132 patterns from classes 2 and 4 respectively. Only the three frequency-based parameters are required for this network as the sole purpose is to separate classes 2 and 4: hence there are three input nodes. Two output nodes are required, hence the number of weights is W=6J+2. For 251 training patterns, a larger number of hidden units can be used: 12 were chosen after some experimentation together with a regularization parameter of 0.025. This gives 74 weights (a ratio of approximately 3.4:1 in number of patterns to number of weights) and good generalisation. The network was trained in the same manner as the first network and the results are presented in Table 3 similarly to Table 2. The accuracies of the three data sets are 85.3%, 76.0% and 79.0% respectively. The classifier is better at identifying patterns from class 4 than from class 2, although the accuracy over the whole set of class 2 patterns is still 64.7%.

TABLE 3
Results of second trained network: (a) Training set;
(b) Remainder of data set; (c) Entire data set

Predicted class

| | | 2 | 4 |
|---|---|---|---|
| Actual | 2 | 89 | 30 |
| class | 4 | 7 | 125 |
| Actual | 2 | 65 | 54 |
| class | 4 | 69 | 324 |
| Actual | 2 | 154 | 84 |
| class | 4 | 76 | 449 |

### Complete Network

Following training of the two networks, the entire set of patterns was passed through the networks, the first stage selecting classes 1, 3 and 2 with 4, the second stage only using the patterns classed as belonging to classes 2 or 4 and dividing them into classes and 4. The results are shown in Table 4. Although there is some degree of misclassification between almost every pair of classes, the majority of each class is still placed in the correct group.

TABLE 4
Confusion table for entire data set

Predicted class

| | | 1 | 2 | 3 | 4 |
|---|---|---|---|---|---|
| Actual | 1 | 18 | 0 | 2 | 12 |
| class | 2 | 1 | 146 | 12 | 79 |
| | 3 | 3 | 3 | 16 | 6 |
| | 4 | 2 | 72 | 51 | 400 |

The accuracy over the entire data set is 70.5%, with 580 of the 823 patterns classified correctly. The most frequent misclassification is of class 2 patterns being classified as belonging to class 4, i.e. oscillating responses being labelled as peak-plateau responses, with some confusion the other way as well. There is also a small fraction of class 2 and class 4 patterns that are classified as being class 3. However, the reasonably high classification accuracy indicates that the Neural Networks used here provide a good generalisation of the discrimination between features necessary for accurate classification.

Various statistical tests can be performed on the results presented in Table 4. The chi-square value is 615.45, which for a system with 9 degrees of freedom, gives a probability of less than 0.0001. The null hypothesis that there is no correlation between the actual and predicted classes can be rejected. Cramer's V, which is a measure of the strength of association among the columns and the rows, is equal to 0.4993, where 0 and 1 denote no relationship and a perfect relationship respectively (25): there is thus a good positive association between the predicted and actual classes. The Goodman-Kruskal index of predictive association gives the two asymmetrical versions of lambda of 0.302 for actual class from predicted class and 0.2546 for predicted class from actual class. The network can be said to be providing a good level of prediction of the correct class.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parenthesis shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for classification of optical intensity variations between cells in a biological sample comprising a plurality of cells of different classes, the system comprising:
means for receiving signals derived from an image captured in respect of an optical imaging conduit containing said plurality of cells within respective wells;
means for deriving a classification scheme which defines classes of cells based on one or more indicative characteristic features of said signals;
means for applying said classification scheme to said received signals to classify at least some of said plurality of cells based on the characteristic features of said received signals; and
means for providing data representative of the classes and respective locations in said conduit array of at least some of said cells.

2. A system according to claim 1, wherein one or more of said predetermined characteristic features of said signals may be determined from light intensity variations within cell-containing regions of said optical conduit array.

3. A system according to claim 2, wherein potential cell-containing regions of said optical imaging conduit are identified from said image and an image mask is generated to mask areas surrounding said potential cell-containing regions of said image, such that only light intensity variations occurring in unmasked areas form the basis for said classification process.

4. A system according to claim 3, wherein said image mask is black and white.

5. A system according to claim 2, further comprising means for receiving a light intensity image representative of said optical imaging conduit containing said plurality of cells.

6. A system according to claim 2, wherein for time-dependent optical intensity variations a time-dependent curve representative of the light intensity is generated in respect of at least each cell-containing well of said optical imaging conduit.

7. A system according to claim 6, wherein said time-dependent curves are compared with a protypic signal response and a set of refined characteristics are extracted for each said curve, said characteristics defining the class of the cell contained in the imaging conduit to which a given curve corresponds.

8. A system according to claim 1, comprising a neural network trained on the indicative characteristic features of protypic signals.

9. A system according to claim 1, arranged and configured to classify time-dependent optical intensity variations of individual cells in a biological sample where cells can be made available in single cell suspension.

10. A system according to claim 9, arranged and configured to classify the intracellular calcium responses of suitably-stimulated lymphocytes.

11. Use of a system according to claim 1, to classify optical intensity variations from a biological sample containing a plurality of cells of different classes.

12. Use of a system according to claim 1, to classify optical intensity variations from a biological sample containing a plurality of cells of different classes made available in a single cell suspension.

13. A method of training a neural network according to claim 8, to perform classification of optical intensity variations between cells by inputting protypic data representative of given cell classes.

14. An optical imaging conduit and imaging system when used to generate said signals received by the classification system according to claim 1.

15. A system according to claim 14, wherein said optical imaging conduit comprises an array of optical fibres, polished at one end and etched at the other end to define respective micro-wells for holding one or more cells of a sample of a plurality of cells.

16. A system according to claim 15, wherein a digital image capture device is arranged to image said micro-wells from the polished end of said optical fibre array.

17. A system according to claim 16, wherein said image capture device is arranged to image said array directly without alteration to the input path.

18. A system according to claim 16, wherein said image capture device is arranged to image said array through variable optical means for altering the light path.

19. A system according to claim 14, wherein the cells contained within the optical conduit array are provided with at least one external physical, chemical or biochemical stimulus to affect the light intensity variation of one or more regions of said image of said array.

20. Apparatus for classification of optical intensity variations between cells in a biological sample comprising a plurality of cells of different classes, the apparatus comprising, in combination, the classification system according to claim 1 together with an optical imaging conduit and imaging system in communication with the classification system.

21. (canceled)
